(19) United States
(12) Patent Application Publication
(10) Pub. No.: US 2023/0261830 A1
(43) Pub. Date: Aug. 17, 2023

(54) TERMINAL, BASE STATION, AND COMMUNICATION METHOD

(71) Applicant: Panasonic Intellectual Property Corporation of America, Torrance, CA (US)

(72) Inventors: Takashi IWAI, Ishikawa (JP); Hidetoshi SUZUKI, Kanagawa (JP); Akihiko NISHIO, Osaka (JP); Ayako HORIUCHI, Kanagawa (JP); Tetsuya YAMAMOTO, Kanagawa (JP)

(21) Appl. No.: 18/004,840

(22) PCT Filed: Jun. 22, 2021
(86) PCT No.: PCT/JP2021/023573

§ 371 Date: Jan. 9, 2023

(30) Foreign Application Priority Data
Jul. 15, 2020 (JP) 2020-121430

(51) Int. Cl. H04L 5/00

(52) U.S. Cl. CPC H04L 5/0051; H04L 5/0064; H04L 5/0007

(57) ABSTRACT

The present invention achieves an improvement in channel estimation accuracy using a reference signal. This terminal comprises: a reception circuit for receiving information indicating any of a plurality of candidates of resources for use in transmitting a reference signal; and a control circuit for controlling, on the basis of the information, an orthogonal sequence that is applied to the reference signal to be transmitted at a certain time.

### TECHNICAL FIELD

The present disclosure relates to a terminal, a base station, and a communication method.

### BACKGROUND ART

In Release 17 of 3rd Generation Partnership Project (3GPP (hereinafter referred to as “Rel. 17”), for the functional extension of Multiple-Input Multiple Output (MIMO) applied to New Radio access technology (NR), improving the coverage performance or capacity performance of a Sounding Reference Signal (SRS) has been discussed (e.g., see Non-Patent Literature (hereinafter referred to as “NPL”) 1).

### CITATION LIST

### Non-Patent Literature

### NPL 1

RP-192436, “WM proposal for Rel. 17 enhancements on MIMO for NR,” Samsung, December 2019

### NPL 2

RP-192435, “Summary of email Discussion for Rel. 17 enhancements on MIMO for NR,” Samsung, December 2019

### SUMMARY OF INVENTION

However, there is scope for further study on a method for improving channel estimation accuracy by using a reference signal.

One non-limiting and exemplary embodiment facilitates providing a terminal, a base station, and a communication method each capable of improving channel estimation accuracy by using a reference signal.

A terminal according to an exemplary embodiment of the present disclosure includes: reception circuitry, which, in operation, receives information indicating any of a plurality of candidates for a resource used for transmitting a reference signal; and control circuitry, which, in operation, controls, based on the information, an orthogonal sequence that is applied to the reference signal to be transmitted at a certain timing.

It should be noted that general or specific embodiment may be implemented as a system, a method, an integrated circuit, a computer program, a storage medium, or any selective combination thereof.

According to an exemplary embodiment of the present disclosure, it is possible to improve channel estimation accuracy by using a reference signal.

Additional benefits and advantages of the disclosed embodiment will become apparent from the specification and drawings. The benefits and/or advantages may be individually obtained by the various embodiments and features of the specification and drawings, which need not all be provided in order to obtain one or more of such benefits and/or advantages,

### BRIEF DESCRIPTION OF DRAWINGS

FIG. 1 illustrates an exemplary Sounding Reference Signal (SRS) to which a Time Domain—Orthogonal Cover Code (TD-OCC) is applied;

FIG. 2 is a block diagram illustrating an exemplary configuration of a part of a base station;

FIG. 3 is a block diagram illustrating an exemplary configuration of a part of a terminal:

FIG. 4 is a block diagram illustrating an exemplary configuration of the base station;

FIG. 5 is a block diagram illustrating an exemplary configuration of the terminal;

FIG. 6 is a sequence diagram illustrating exemplary operations of the terminal and the base station;

FIG. 7 illustrates an exemplary SRS resource set;

FIG. 8 illustrates an example of trigger information;

FIG. 9 illustrates an exemplary SRS configuration;

FIG. 10 illustrates another exemplary SRS configuration;

FIG. 11 illustrates an example of TD-OCC information;

FIG. 12 illustrates an example of Drop of the SRS;

FIG. 13 illustrates still another exemplary SRS configuration;

FIG. 14 illustrates still another exemplary SRS configuration;

FIG. 15 illustrates yet another exemplary SRS configuration;

FIG. 16 illustrates an exemplary architecture of a 3GPP NR system;

FIG. 17 schematically illustrates a functional split between Next Generation—Radio Access Network (NG-RAN) and 5th Generation Core (5 GC);

FIG. 18 is a sequence diagram of a Radio Resource Control (RRC) connection setup/reconfiguration procedure;

FIG. 19 schematically illustrates usage scenarios of enhanced Mobile BroadBand (eMBB), massive Machine Type Communications (mMTC), and Ultra Reliable and Low Latency Communications (URLLC); and

FIG. 20 is a block diagram illustrating an exemplary 5G system architecture for a non-roaming scenario.

### DESCRIPTION OF EMBODIMENTS

Hereinafter, an embodiment of the present disclosure will be described in detail with reference to the accompanying drawings.

For an SRS used in NR (e.g., referred to as “NR SRS”), for example, a base station (e.g., sometimes referred to as “eNB” or “gNB”) may indicate (or configure) information on a configuration of an SR.S (hereinafter referred to as “SRS configuration information”) to a terminal (e.g., sometimes referred to as “User Equipment” (UE)). For the SRS configuration information, for example, “SRS resource set” may be defined, which is a parameter group used for each SRS resource, such as a transmission timing of an SRS, a transmission frequency band for an SRS, a sequence number for reference signal generation, and a cyclic shift amount. The SRS configuration information may be configured by, for example, higher layer signaling such as a Radio Resource Control (RRC) layer. The SRS configuration information is also sometimes referred to as, for example, “SRS-Confit” which is configured in the RRC layer.

Further, in the NR SRS, a use case of an SRS may be configured for the SRS resource set, such as downlink channel quality estimation for downlink MIMO transmission (e.g., also referred to as “Antenna switching”), uplink channel quality estimation for uplink MIMO transmission (e.g., also referred to as “Code book” or “Non-code book”), or beam control (e.g., also referred to as “beam management”). For example, the terminal may perform SRS transmission according to the use case configured for the SRS resource set.

Further, the NR SRS may support, for example, time domain operations (Time domain SRS behaviors) of three types: a Periodic SRS, a Semi-persistent SRS, and an Aperiodic SRS. For example, any of time domain operations of three types may be configured for the SRS resource set.

For example, the Periodic SRS and the Semi-persistent SRS are periodically transmitted SRSs. In the Periodic SRS and the Semi-persistent SRS, for example, a transmission slot period and transmission slot offset may be configured for the SRS resource set, and at least one of the RRC layer and Medium Access Control (MAC) layer may indicate ON and OFF of the transmission.

Meanwhile, for example, the Aperiodic SRS is an aperiodically transmitted SRS. In the Aperiodic SRS, for example, the transmission timing may be indicated by trigger information (e.g., “SRS resource indicator (SRI)”) included in a downlink control channel (e.g., Physical Downlink Control Channel (PDCCH)) in the physical layer. For example, the terminal may transmit the Aperiodic SRS when Aperiodic SRS transmission is requested by the trigger information. For example, the terminal may transmit the Aperiodic SRS at a timing after the slot offset configured, by the RRC layer, for the SRS resource set from the slot that has received the trigger information. For example, the base station can dynamically (or instantaneously) indicate, to the terminal, the Aperiodic SRS transmission at a predetermined band or timing for channel estimation with a transmission beam.

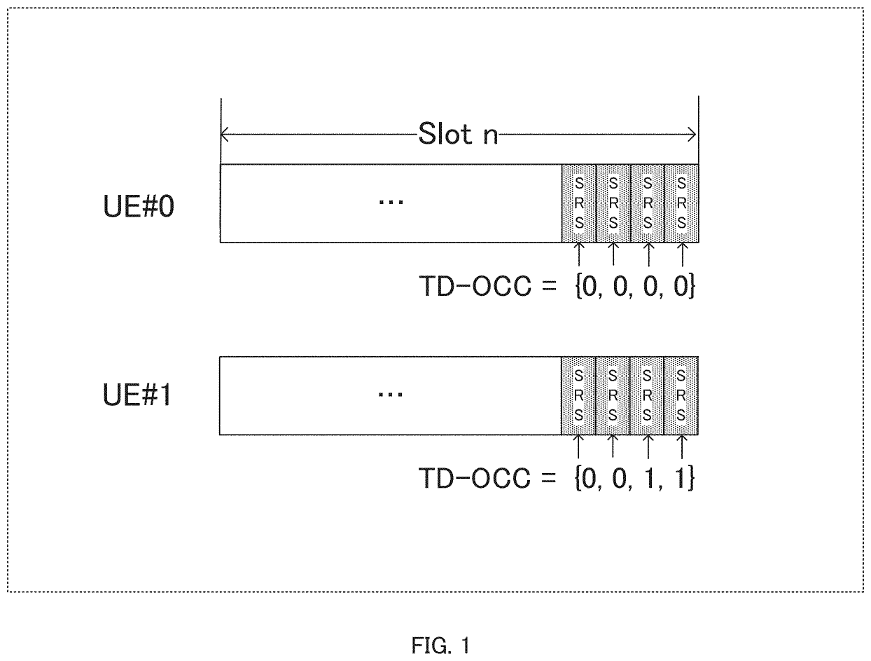

Further, in Rel. 17, as illustrated in FIG. 1, for example, application of a Time Domain—Orthogonal Cover Code(TD-OCC) in which an SRS symbol to be repeated in a slot is multiplied by an orthogonal sequence has been proposed (e.g., see NPL 2). The application of the TD-OCC is expected to improve the SRS performance.

In one example, the terminal repeatedly transmits (or performs repetition transmission) a signal of the SRS symbol in the slot, thereby allowing a symbol combination gain at the base station on a reception side. This makes it possible to, for example, improve channel estimation accuracy with the SRS from a terminal in which a transmission power is near the upper limit, such as a terminal located at a cell edge. In addition, the application of the TD-OCC makes it possible to increase the number of terminals that can be transmitted (i.e., the number of multiplexes) in the same radio resource.

For example, in the example of FIG. 1, each of UE #0 and UE #1 transmits the SRS in the last four symbols of the slot. The SRS symbols transmitted by each UE #0 and UE #1 are multiplied by OCC sequences of {0, 0, 0, 0} and {0, 0, 1, 1}, respectively. In FIG. 1, for example, when the base station receives the SRS of UE #0, the base station multiplies the four SRS symbols by the OCC sequence of {0, 0, 0, 0} used by LIE #0 at the time of transmission and in-phase combines the four symbols to cancel an interference component from UE #1, thereby extracting a signal component from UE #0. In the same manner, when receiving the SRS of UE #1 in FIG. 1, the base station may extract a signal component from UE #1 by canceling an interference component from UE #0.

Here, in the application of the TD-OCC to the SRS. an interference occurs when the orthogonality of the orthogonal sequences (e.g., OCC sequence) between terminals collapses, which may deteriorate the channel estimation accuracy using the multiplexed SRS. By way of example, the orthogonality of the OCC sequences collapses even in a case where a symbol position in the slot is shifted by one symbol or the OCC sequence is shifted by one bit, and thus, an interference may occur with respect to a plurality of SRSs (e.g., a plurality of terminals) multiplexed into the same resource. The interference occurrence may deteriorate the channel estimation accuracy using the SRS, for example.

Meanwhile, for example, in a case where the SRS transmission timing or the OCC sequence is configured by the SRS configuration information that is configured by the RRC layer as in the NR SRS, it is difficult to flexibly (i.e., dynamically) schedule an Aperiodic SRS in which the orthogonality between OCC sequences of a plurality of terminals is maintained by the base station.

Accordingly, in an exemplary embodiment of the present disclosure, a description will be given of a method for improving the channel estimation accuracy using an SRS by flexibly scheduling an Aperiodic SRS with respect to a terminal.

### Embodiment 1

### Overview of Communication System

A communication system according to an aspect of the present disclosure may include, for example, base station 100 (e.g., gNB or eNB) and terminal 200 (e.g., UE).

For example, base station 100 may be a base station for NR, and terminal 200 may be a terminal for NR. Base station 100 may trigger, on terminal 200, Aperiodic SRS transmission with the TD-OCC applied and receive an Aperiodic SRS, for example. Terminal 200 may transmit, based on the trigger information from base station 100, an Aperiodic SRS with the TD-OCC applied, for example.

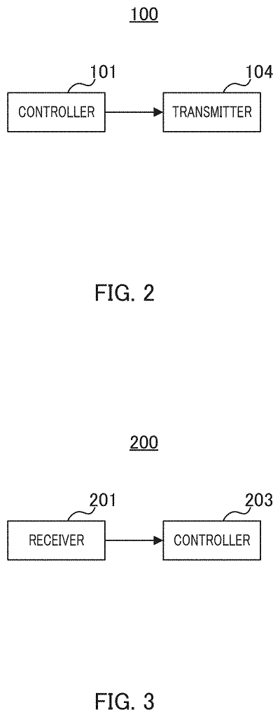

FIG. 2 is a block diagram illustrating a configuration example of a part of base station 100 according to an aspect of the present disclosure. In base station 100 illustrated in FIG. 1, transmitter 104 transmits information e.g., trigger information) indicating any of a plurality of candidates for the resource used for transmitting a reference signal (e.g., SRS). Controller 101 controls, based on the information, an orthogonal sequence (e.g., OCC sequence) to be applied to a reference signal to be received at a certain timing.

FIG. 3 is a block diagram illustrating an exemplary configuration of a part of terminal 200 according to an aspect of the present disclosure. In terminal 200 illustrated in FIG. 3, receiver 201 receives the information indicating any of a plurality of candidates for the resource used for transmitting a reference signal (e.g., SRS). Controller 203 controls, based on the information, an orthogonal sequence (e.g., OCC sequence) to be applied to a reference signal to be transmitted at a certain timing.

### Configuration of Base Station

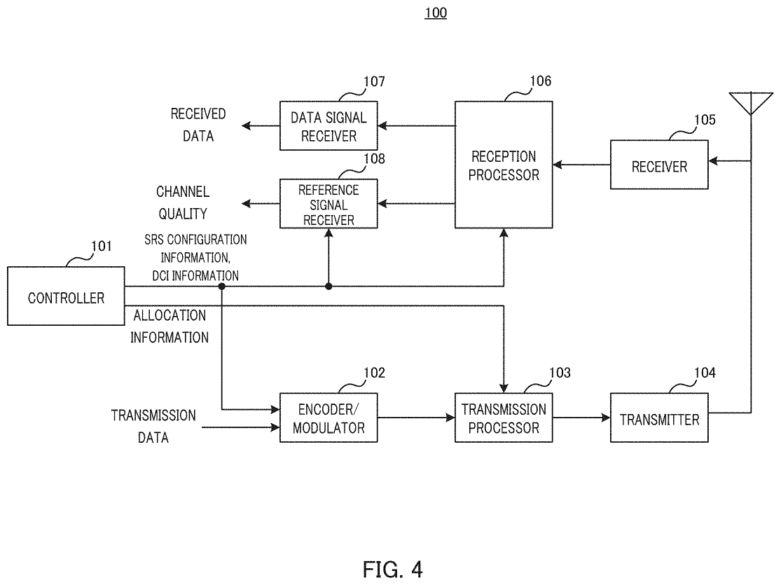

FIG. 4 is a block diagram illustrating an exemplary configuration of base station 100 according to an aspect of the present disclosure. In FIG. 4, base station 100 may include, for example, controller 101, encoder/modulator 102, transmission processor 103, transmitter 104, receiver 105, reception processor 106, data signal receiver 107, and reference signal receiver 108.

Controller 101 may control SRS scheduling, for example. In one example, for terminal 200 on which the Aperiodic SRS transmission is triggered, controller 101 may generate the SRS configuration information, or downlink control information e.g., DCI) that is used for requesting the Aperiodic SRS transmission.

The SRS resource set of the SRS configuration information may include, for example, sequence information on the TD-OCC to be applied to the SRS (e.g., sequence length, sequence pattern, and the like) and an SRS symbol position in a slot (e.g., symbol number, or starting symbol position and sequential symbol length (number of Repetitions) when sequential arrangement is assumed).

Moreover, the SRS resource set of the SRS configuration information may include, in addition to the sequence information on the TD-OCC and the SRS symbol position in the slot, a parameter such as a transmission frequency band for each SRS resource (e.g., including the number of transmission Combs), the number of SRS ports, a sequence number for reference signal generation, a cyclic shift amount (e.g., Cyclic Shift value), frequency hopping, or sequence hopping, for example.

Furthermore, for example, a plurality of SRS resource sets can be configured in the SRS configuration information. Further, for example, one trigger number indicatable by the trigger information can be configured for each SRS resource set for an Aperiodic SRS. Terminal 200 may apply, for example, the SRS resource set associated with the trigger number indicated by the trigger information.

The DCI may include a few bits of the trigger information for the Aperiodic SRS (e.g., SRI field), for example. For example, a trigger number of the Aperiodic SRS (e.g., SRS resource set for Aperiodic SRS) of the number corresponding to the number of bits of the trigger information (e.g., number of values representable by bits of trigger information) may be associated with each value representable by bits of the trigger information. In one example, in a case where the trigger information has two bits (e.g., representable value: four values), “no request (or No Trigger) for SRS transmission” and the trigger numbers for three Aperiodic SRSs may be associated with the trigger information. When the trigger information has two bits, base station 100 may select and trigger, on terminal 200, three different OCC sequence numbers or Aperiodic SRS transmission associated with different symbol positions in the slot, for example.

Incidentally, a plurality of SRS resource sets may be associated with one trigger number. This association allows, for example, the Aperiodic SRS transmission using a plurality of slots to be triggered with one trigger information.

Controller 101 may, for example, output the control information including the SRS configuration information generated as described above to encoder/modulator 102. The SRS configuration information may be transmitted, for example, as control information for RRC layer (i.e., higher layer signaling or RRC signaling), to terminal 200 which is a target after transmission processing has been performed in encoder/modulator 102, transmission processor 103, and transmitter 104.

Controller 101 may, for example, output the DCI including the trigger information for the Aperiodic SRS transmission generated as described above to encoder/modulator 102. The DCI may be transmitted, for example, as control information for layer 1 or layer 2, to terminal 200 which is a target after transmission processing has been performed in encoder/modulator 102, transmission processor 103, and transmitter 104.

As described above, while the SRS configuration information is indicated from base station 100 to terminal 200 by, for example, higher layer signaling, the DCI including the trigger information may be indicated from base station 100 to terminal 200 by a PDCCH. For example, since the DCI has a shorter indication interval (or transmission interval) as compared to the SRS configuration information, base station 100 may dynamically (or instantaneously) indicate the trigger information according to the communication status of each terminal 200.

Further, controller 101 may, for example, control reception of the Aperiodic SRS based on the SRS configuration information and the trigger information. For example, controller 101 may output the SRS configuration information and the trigger information to reception processor 106 and reference signal receiver 108.

Incidentally, the DCI may include, in addition to the trigger information for the Aperiodic SRS, other information such as allocation information on a frequency resource for uplink data or downlink data (e.g., Resource Block (RB)) and information on encoding and modulation scheme for data (e.g., Modulation and Coding Scheme (MCS)), for example. Controller 101 may output, to transmission processor 103, the allocation information on a radio resource for the downlink data transmission, for example.

Encoder/modulator 102 may, for example, encode and modulate the SRS configuration information or the DC1 input from controller 101 and output the resulting modulation signal to transmission processor 103. Encoder/modulator 102 may also, for example, encode and modulate the data signal (or transmission data) to be input and output the resulting modulation signal to transmission processor 103.

Transmission processor 103 may, for example, form a transmission signal by mapping the modulation signal input from encoder/modulator 102 to a frequency band in accordance with the allocation information on the radio resource for the downlink data transmission input from controller 101. For example, in a case where the transmission signal is an orthogonal frequency division multiplexing (OFDM) signal, transmission processor 103 may map the modulation signal to a frequency resource, convert the mapped signal into a time waveform through inverse fast Fourier transform (IFFT) processing, add a Cyclic Prefix (CP), and thereby form the OFDM signal.

Transmitter 104 may, for example, on the transmission signal input from transmission processor 103, perform transmission radio processing such as up-conversion and digital-analog (D/A) conversion, and transmit the transmission signal resulting from the transmission radio processing via an antenna.

Receiver 105 may, for example, on a radio signal received via the antenna, perform reception radio processing such as down-conversion and analog-to-digital (A/D) conversion, and output the received signal resulting from the reception radio processing to reception processor 106.

Reception processor 106 may, for example, identify a resource to which the uplink data signal is mapped, based on the information input from controller 101, and extract a signal component mapped to the identified resource from the received signal.

Reception processor 106 may also identify the resource to which the Aperiodic SRS is mapped, based on the SRS configuration information and the DCI (e.g., trigger information) input from controller 101, and extract a signal component mapped to the identified resource from the received signal. For example, reception processor 106 may receive the Aperiodic SRS in the SRS resource (e.g., slot based on slot offset) which is configured for the SRS resource set(s) associated with the trigger number of the Aperiodic SRS indicated by the trigger information.

Reception processor 106, for example, outputs the extracted uplink data signal to data signal receiver 107 and outputs an Aperiodic SRS signal to reference signal receiver 108.

Data signal receiver 107 may, for example, decode a signal input from reception processor 106 and output uplink data (or received data).

Reference signal receiver 108 may, for example, measure received quality of each frequency resource to which an Aperiodic SRS is mapped, based on the Aperiodic SRS input from reception processor 106 and the parameter information of the SRS resource set input from controller 101, and output information on the received quality. Here, reference signal receiver 108 may, for example, perform separation processing of the Aperiodic SRS, based on the SRS configuration information and the DCI (e.g., trigger information) input from controller 101. This separation processing may he performed by, for example, identifying the sequence information on the TD-OCC applied to the Apedodic SRS transmitted from terminal 200 which is a target and the symbol position in the slot, multiplying each received SRS symbol by the OCC sequence, and thereby in-phase combining.

### Configuration of Terminal

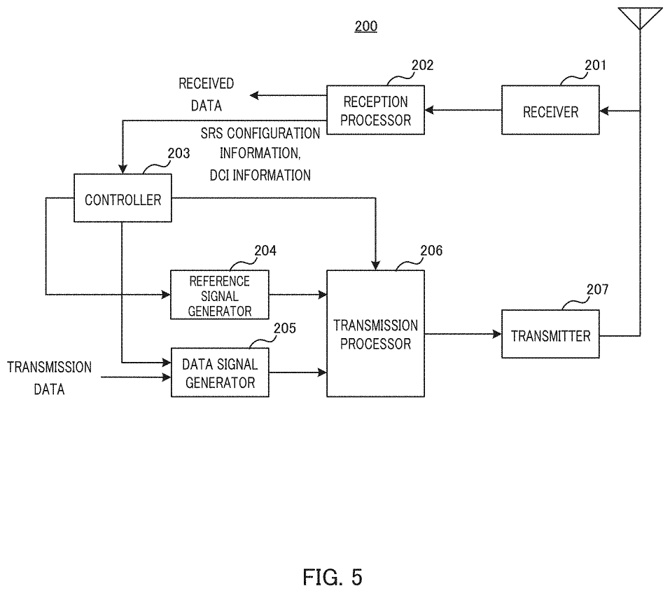

FIG. 5 is a block diagram illustrating an exemplary configuration of terminal 200 according to an aspect of the present disclosure. In FIG. 5, terminal 200 may include, for example, receiver 201, reception processor 202, controller 203, reference signal generator 204, data signal generator 205, transmission processor 206, and transmitter 207.

Receiver 201 may, for example, on a radio signal received via the antenna, perform reception radio processing such as down-conversion and analog-to-digital (A/D) conversion, and output the received signal resulting from the reception radio processing to reception processor 202.

Reception processor 202 may, for example, extract the SRS configuration information and the DCI included in a received signal input from receiver 201. and output the extracted information to controller 203. Reception processor 202 may also, for example, decode a downlink data signal included in the received signal and output the decoded downlink data signal (or received data). Incidentally, in a case where the received signal is an OFDM signal, reception processor 202 may, for example, perform CP removal processing, and Fourier transform (Fast Fourier Transform: FFT) processing.

Controller 203 may, for example, control transmission of the Aperiodic SRS, based on the SRS configuration information and the DCI (e.g., trigger information) input from reception processor 202. For example, when controller 203 detects, from the trigger information, an indication from base station 100 regarding the Aperiodic SRS transmission, controller 203 identifies the SRS resource set to be used for transmitting the Aperiodic SRS, based on the SRS configuration information and the trigger information. Controller 203 may then, for example, extract SRS resource information (e.g., frequency resource information, reference signal information, TD-OCC sequence information, and the like) to be applied to the Aperiodic SRS, based on the identified SRS resource set, and output (or indicate to or configure for) the extracted information to reference signal generator 204.

Further, controller 203 may, for example, identify the frequency resource information and the MCS to which an uplink data signal is mapped, based on the DCI input from reception processor 202, and output the frequency resource information to transmission processor 206 and output the MCS information to data signal generator 205.

Upon receiving an indication for generating a reference signal from controller 203, reference signal generator 204 may, for example, generate a reference signal (e.g., Aperiodic SRS) based on the SRS resource information including the OCC sequence number input from controller 203 or the symbol position information in the slot and then output the resultant reference signal to transmission processor 206.

Data signal generator 205 may, for example, generate a data signal by encoding and modulating transmission data (or uplink data signal) to be input, based on the MCS information input from controller 203. Data signal generator 205 may, for example, output the generated data signal to transmission processor 206.

Transmission processor 206 may, for example, map the Aperiodic SRS that is input from reference signal generator 204 to the frequency resource indicated from controller 203. Transmission processor 206 may also, for example, map the data signal that is input from data signal generator 205 to the frequency resource indicated from controller 203. Thus, a transmission signal is formed. In a case where the transmission signal is an OFDM signal, transmission processor 206 may, for example, perform the IFFT processing on the signal after the mapping to the frequency resource and then add the CP.

Transmitter 207 may, for example, on the transmission signal formed in transmission processor 206, perform transmission radio processing such as up-conversion and digital-analog (D/A) conversion, and transmit the signal resulting from the transmission radio processing via an antenna.

### Operations of Base Station 100 and Terminal 200

A description will be given of exemplary operations of base station 100 and terminal 200 having the above-mentioned configurations.

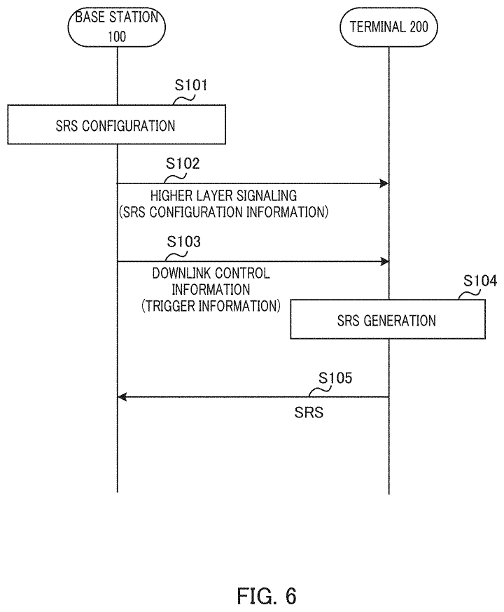

FIG. 6 is a sequence diagram illustrating exemplary operations of base station 100 and terminal 200.

Base station 100, for example, makes a configuration on an Aperiodic SRS for terminal 200 (S101). In one example, base station 100 may generate SRS configuration information related to the configuration of the Aperiodic SRS.

Base station 100, for example, transmits (or configures or indicates) the SRS configuration information to terminal 200 by higher layer signaling (e.g., RRC layer signal) (S102).

For example, when requesting the SRS transmission, base station 100 transmits, to terminal 200, downlink control information (e.g., DCI) including the trigger information indicating any of the SRS configuration information (e.g., SRS resource set) configured for terminal 200 (S103).

Terminal 200, for example, generates an Aperiodic SRS, based on the SRS configuration information transmitted from base station 100 and the trigger information (S104) and transmits the generated Aperiodic SRS to base station 100 (S105). Base station 100, for example, receives the Aperiodic SRS from terminal 200, based on the SRS configuration information and the trigger information that have been transmitted to terminal 200.

### Generation Method of Trigger Information for Aperiodic SRS

An exemplary method for generating trigger information for an Aperiodic SRS in base station 100 (e.g., controller 101) will be described.

For example, at least one of sequence information on the Aperiodic SRS with the TD-OCC applied (e.g., sequence number (or sequence pattern) and sequence length) and the information on the SRS symbol position in the slot may be associated with the trigger information for the Aperiodic SRS included in the DCI. Further, for example, the trigger information may configure at least one of the sequence information on the Aperiodic SRS and the SRS symbol position to be changeable.

The following describes an example of indicating sequence information and an SRS symbol position by the trigger information.

### EXAMPLE 1

In Example 1, for example, base station 100 may configure, for terminal 200, SRS configuration information including SRS resource information (e.g., SRS resource set) such as sequence information on the Aperiodic SRS and SRS symbol position information by the RRC layer.

Further, base station 100 may, for example, associate the trigger information with the SRS resource information (e.g., SRS resource set) included in the SRS configuration information. Thus, for example, base station 100 can indicate, to terminal 200, the SRS resource information h the trigger information (i.e., dynamic signaling).

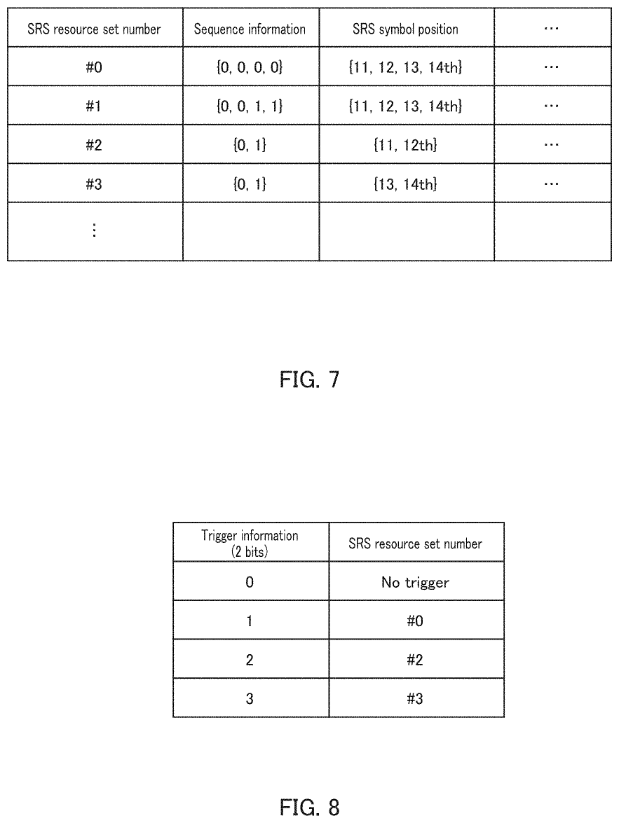

For example, FIG. 7 illustrates examples of configurations of the sequence information and the SRS symbol position information (i.e., candidate for resource used for transmitting SRS) for each SRS resource set number included in the SRS configuration information. In one example, in NR, a slot is composed of 14 symbols. Therefore, in the example illustrated in FIG. 7, the SRS symbol position of SRS resource set number=0 indicates that the fourth symbol (11th from head) from the end of the slot (14th from head) is configured as the start symbol position and the SRS symbol length (sequence length) is four symbols. The same applies to other SRS resource set numbers.

FIG. 8 illustrates an association example between the trigger information and the SRS resource set number. As illustrated in FIG. 8, an association relation between a value (e.g., zero to four representable by the number of bits of the trigger information (e.g., two bits) and an SRS resource set number may be configured and may be indicated to terminal 200 in advance by the RRC layer. In FIG. 8, for example, three patterns of combinations of the sequence information and the SRS symbol position are associated with the trigger information.

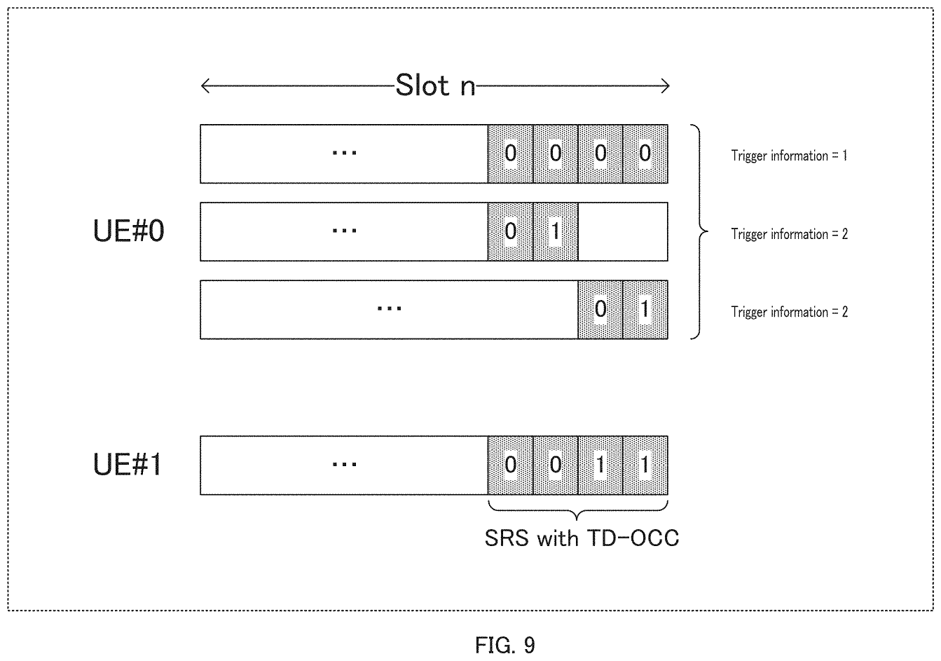

FIG. 9 illustrates an exemplary SRS configuration for terminals 200 (e.g., UE #0 and UE #1).

For example, in a case where the Aperiodic SRS is triggered for UE #0 illustrated in FIG. 9, one of pieces of the trigger information=1 to 3 illustrated in FIG. 8 may be indicated. As an example, in a case where UE #0 and UE #1 (sequence length=4, sequence pattern={0, 0, 1, 1}) are multiplexed as illustrated in FIG. 9, the orthogonality of SRSs between UE #0 and UE #1 is maintained even in SRSs of any pattern of trigger information=1 to 3.

This allows base station 100 to execute scheduling control for the SRS according to the communication status of terminal 200, for example.

For example, when the communication environment of UE #0 is good, the symbol combination gain on the reception side is enough to be small, and thus, base station 100 may trigger, on UE #0, Aperiodic SRS transmission with a shorter sequence length (SRS symbol length) (e.g., trigger information=2 or 3). As a result, the consumption of the SRS transmission resource can be suppressed.

Meanwhile, for example, when the communication environment of UE #0 is poor, the symbol combination min on the reception side is better larger, and thus, base station 100 may trigger, on UE #0, Aperiodic SRS transmission with a longer sequence length (SRS symbol length) (e.g., trigger information=1). This can improve the channel estimation accuracy with the SRS.

Further, an DCI signaling amount may be reduced by, for example, maintaining the orthogonality of SRSs with the TD-OCC and including some of the possible combinations of the sequence information and the SRS symbol position information. in the trigger information. In one example, the sequence information and the SRS symbol position information indicated by the trigger information may be configured (or limited) in the following manner. The following will describe, for example, a case where a slot is composed of 14 symbols and the allocatable OCC sequence length=8, as in NR.

A start position of the SRS symbol to which the OCC sequence of sequence length=8 is applied may be, for example, the (8+X)th symbol from the end of the slot (X is integer of from zero to six). Further, a start position of the SRS symbol to which the OCC sequence of sequence length=4 is applied may be, for example, the (8+X)th or (4+X)th symbol from the end of the slot. Further, a start position of the SRS symbol to which the OCC sequence of sequence length=2 is applied may be, for example, the (8+X)th, (6+X)th, (4+X.)th, or (2+X) symbol from the end of the slot.

In other words, a symbol position different from the start position of the SRS described above need not be indicated by the trigger information. Thus, the candidates indicatable by the trigger information may be some of a plurality of candidates for the SRS configuration information (e.g., SRS resource such as SRS symbol position). This can maintain the orthogonality between various SRSs and reduce the DCI signaling amount even when an OCC sequence of any sequence length is applied.

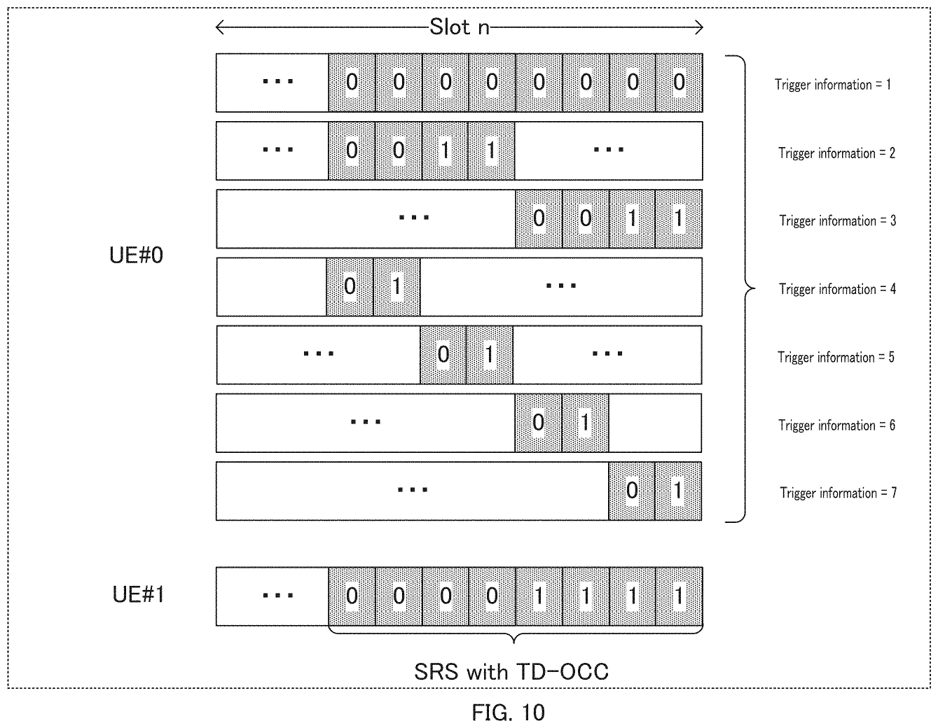

As an example, FIG. 10 illustrates an exemplary SRS configuration when a TD-OCC of up to sequence length=8 is applied.

As illustrated in FIG. 10, candidates for the SRS resource configured by the trigger information for UE 40 may be configured (or limited) to eight patterns (trigger information=1 to 7). In the example illustrated in FIG. 10, even when any trigger information is indicated to UE #0, the orthogonality of SRSs between UE #0 and the UE #1 can be maintained. Further, as illustrated in FIG. 10, configuring (or limiting) the candidates for the SRS resource indicatable by the trigger information can suppress an overhead of the trigger information.

Incidentally, for example, a length corresponding to the SRS symbol length may be applied to the sequence length of the TD-OCC, and thus, in the SRS resource set, an OCC sequence number such as #0 and #1 may be configured for the sequence information, instead of the sequence pattern as in FIG. 7.

Further, for example, an upper limit of the OCC sequence length applied to terminal 200 may be set in advance, In this case, base station 100 may determine the number of bits of the trigger information to be included in the DCI, according to the upper limit of the sequence length. For example, for terminal 200 for which the upper limit value of the OCC sequence length is set to four, the number of bits of the trigger information is determined to be two bits, as illustrated in FIG. 9, and for terminal 200 for which the upper limit value of the OCC sequence length is set to eight, the number of bits of the trigger information may be determined to be three bits, as illustrated in FIG. 10.

### EXAMPLE 2

In Example 2, base station 100 may include in the DCI and indicate, separately from the trigger information, at least one of the sequence information and the SRS symbol position information (hereinafter referred to as “TD-OCC information”), for example.

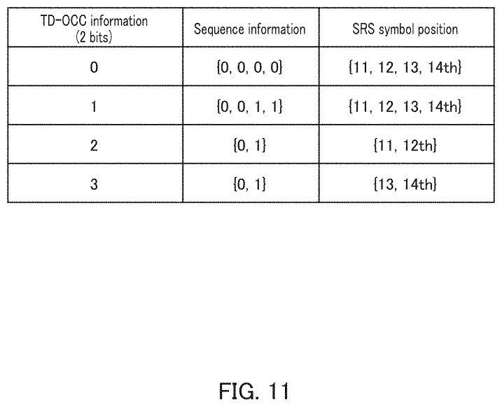

FIG. 11 illustrates an exemplary association (e.g., table) between TD-OCC information and a combination of sequence information and SRS symbol positions. For example, base station 100 may include the TD-OCC information illustrated in FIG. 11 (e.g., two bits) in the DCI and indicate the information to terminal 200.

In Example 2, for example, as in Example 1, an DCI signaling amount may be reduced by maintaining the orthogonality of SRSs with the TD-OCC and including some of the possible combinations of the sequence information and the SRS symbol position information in the TD-OCC information.

Note that, as illustrated in FIG. 7, for example, in a case where the sequence information or the SRS symbol position information is also configured for the SRS resource set, terminal 200 may apply an indication of either the SRS resource set (e.g., trigger information) or the TD-OCC information, by giving a priority (overwriting).

The indication examples of the sequence information and the SRS symbol position by the trigger information have been each described, thus far.

Thus, in the present Embodiment, base station 100, for example, transmits the SRS configuration information including a plurality of candidates for a parameter e.g., sequence information or SRS symbol position) related to SRS multiplied by an OCC sequence over a plurality of symbols, and the DCI (e.g., trigger information or TD-OCC information) indicating any of the plurality of candidates included in the SRS configuration information. Terminal 200, for example, controls the Aperiodic SRS transmission based on the SRS configuration information and the DCI from base station 100, and base station 100 controls the Aperiodic SRS reception based on the SRS configuration information and the DCI transmitted to terminal 200.

The indication on the TD-OCC by the DCI enables base station 100 to, for example, dynamically adjust, by the DCI, the OCC sequence and the SRS symbol position of the Aperiodic SRS with the TD-OCC applied, with respect to terminal 200. Therefore, according to the present Embodiment, it is possible to trigger, on terminal 200, the Apedodic SRS transmission maintaining the orthogonality between SRSs by the TD-OCC, and thereby improving the channel estimation accuracy with the SRS.

Further, in the present Embodiment, for example, it is possible to suppress an overhead increase of the trigger information by maintaining the orthogonality of SRSs and limiting the OCC sequence or the SRS symbol position that can be configured (or changed) by the DCI to a portion thereof.

### Embodiment 2

In the present embodiment, a description will be given of a method for transmitting an SRS in a situation where a transmission timing of the SRS with the TD-OCC applied and a transmission timing of another uplink signal (or, uplink channel) collides (e.g., a case where transmission symbol positions match).

### Collision of SRS with TD-OCC Applied

In an NR SRS, for example, a priority when an SRS collides with another uplink signal is specified by the specifications (or standards). By way of example, in one terminal, when a collide occurs in transmission timing between a Semi-persistent (SP) SRS and an uplink control channel (e.g., Physical Uplink Control Channel: PUCCH) that transmits Semi-persistent Channel State Information (SP-CSI), the PUCCH is given priority. In other words, the specifications specify the priority relation of “PUCCH with SP-CSI>SP-SRS.” For example, among symbols in which the SRS having a lower priority than the PUCCH with SP-CSI are placed, an SRS symbol whose transmission timing collides with the PUCCH with SP-CSI may be dropped (not transmitted), and an SRS symbol having a different transmission timing from the PUCCH with SP-CSI may be transmitted.

However, when some of the SRS symbols for the SRS with the TD-OCC applied are dropped, the orthogonality of TD-OCCs may collapse.

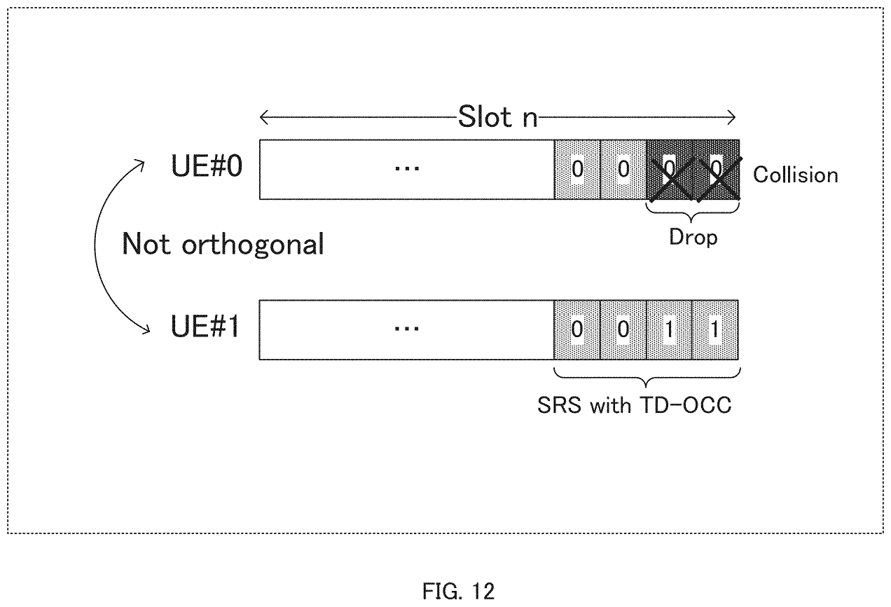

FIG. 12 illustrates an example of a case where some of the SRS symbols for the SRS with the TD-OCC applied are dropped. In the example illustrated in FIG. 12, an SRS of the sequence pattern {0,0,0,0} is configured for UE #0, whereas an SRS of the series pattern {0,0,1,1} is configured for UE #1, and the SRSs are orthogonal between UE #0 and UE #1.

In FIG. 12, for example, in UE #0, a collide occurs in transmission timing between the two symbols at the end of the slot and another uplink signal (e.g., PUCCH); accordingly, among the SRS of the four symbols, the two SRS symbols each having a lower priority are dropped. Thus, when the two symbols at the end of the slot are dropped in UE #0, the orthogonality of the SRSs with the OCC sequences between UE #0 and UE #1 collapses, and both UE #0 and UE #1 have interference in the SRSs, which may reduce the channel estimation accuracy.

Hence, in the present Embodiment, an improved operation example in a case of the SRS dropping with the TD-OCC applied will be described.

As to the configuration examples of a base station and a terminal according to the present Embodiment, for example, some functions may be different from Embodiment 1 while other functions may he the same as in Embodiment 1.

### Configuration of Base Station

In base station 100 according to the present Embodiment, reception processor 106 may determine whether terminal 200 has transmitted the SRS with the TD-OCC applied at, for example, a transmission timing of the SRS with the TD-OCC applied. For example, when determining that terminal 200 has transmitted the SRS with the TD-OCC applied, reception processor 106 may perform reception processing of the SRS and output a reception processing result to reference signal receiver 108. On the other hand, when determining that terminal 200 has not transmitted the SRS with the TD-OCC applied, reception processor 106 may be configured not to perform the reception processing of the SRS.

An example of transmission determination processing, in base station 100, for the SRS with the TD-OCC applied will he described later. Further, other processing in base station 100 may he the same as in Embodiment 1.

### Configuration of Terminal

In terminal 200 according to the present Embodiment, transmission processor 206 may determine whether to transmit the SRS at, for example, a transmission timing of the SRS with the TD-OCC applied. For example, when determining to transmit the SRS with the TD-OCC applied, transmission processor 206 may perform transmission processing of the SRS and output a transmission processing result to transmitter 207. On the other hand, for example, when determining not to transmit the SRS with the TD-OCC applied, transmission processor 206 may be configured not to perform the transmission processing of the SRS.

An example of transmission determination processing, in terminal 200, for the SRS with the TD-OCC applied will be described later. Further, other processing in terminal 200 may be the same as in Embodiment 1.

### Transmission Determination Processing of SRS with TD-OCC Applied

In a case where a transmission timing of the SRS with the TD-OCC applied collides with a transmission timing of another uplink signal, base station 100 and terminal 200 may, for example, control transmission or reception of the SRS (e.g., application of OCC sequence to SRS) based on a priority of each of the SRS and the other uplink signal. For example, the priority may be different from each other between the SRS with the TD-OCC applied and the other uplink signal.

### EXAMPLE 1

In Example 1, for example, a priority when a transmission timing of the SRS with the TD-OCC applied and a transmission timing of the other uplink signal collides may be defined by the specification (or standards). Alternatively, the priority may be configured for terminal 200 by the RRC layer or may be indicated to terminal 200 by the DCI. The configuration (or indication) relating to the priority may be a combination of the specifications, the RRC layer, and the DCI.

For example, when information indicating the priority of the DCI (e.g., Priority indicator) is configured for terminal 200 by the RRC layer, terminal 200 may determine the priority of the SRS based on the Priority indicator of the DCI. On the other hand, when the Priority indicator of the DCI is not configured for terminal 200 by the RRC layer, terminal 200 may apply the priority configured by the RRC layer, for example.

In one example, the priority at the time of collision of the SRS with the TD-OCC applied may be configured higher than that of SRS with the TD-OCC not applied. Further, for example, the priority at the time of collision of the SP-SRS with the TD-OCC applied may be configured higher than that of a PUCCH that transmits the SP-CSI. On the other hand, the priority of the SP-SRS with the TD-OCC not applied may be configured lower than that of the PUCCH that transmits the SP-CSI, for example. That is, the priority relation of “SP-SRS with TD-OCC>PUCCH with SP-CSI>SP-SRS without TD-OCC” may be specified by the specifications or configured for terminal 200.

For example, as described above, the case will be described where the collide occurs in transmission timing between the two symbols at the end of the slot and another uplink signal (e.g., PUCCH) in UE #0 illustrated in FIG. 12.

In Example 1, since the priority of the SRS with the TD-OCC applied is higher than the priority of the PUCCH (e.g., PUCCH with SP-CSI), UE 40 transmits the SRS placed in four symbols. In other words, among the four symbols, the SRS is transmitted (or not dropped) in some symbols where a collide occurs in transmission timing with the PUCCH,

Thus, in Example 1, terminal 200 may execute the control for the TD-OCC described above when the priority is higher in the SRS than in the PUCCH. In one example, since UE #0 illustrated in FIG. 12 transmits the SRS of four symbols with the TD-OCC applied, the orthogonality of the SRSs with the OCC sequences between UE #0 and UE #1 is maintained. Therefore, it is possible to suppress the occurrence of interference in the SRSs in both UE #0 and UE #1 and thus to improve the channel estimation accuracy.

Note that, an SRS to which the priority at the time of collision is applied is not limited to, for example, the SRS with the TD-OCC applied. In one example, similarly to the SRS with the TD-OCC applied, the priority can be applied to an SRS to be used for the coverage performance or the capacity performance of the SRS. For example, a different priority as in Example 1 may be configured for, as a use case of the SRS to be configured in the SRS resource set, a use case which is newly defined and is different from the existing use case, such as downlink channel quality estimation for downlink MIMO transmission (“Antenna switching” in SRS resource set), uplink channel quality estimation for uplink MIMO transmission (“Code book” or “Non-code book” in SRS resource set), or beam-control (“beam management” in SRS resource set).

### EXAMPLE 2

In Example 2, in a case where the priority of the SRS with the TD-OCC applied is lower than the priority of another uplink signal, for example, terminal 200 may drop the SRS including SRS symbols that do not collide with the other uplink signal among a plurality of SRS symbols of the SRS with the TD-OCC applied.

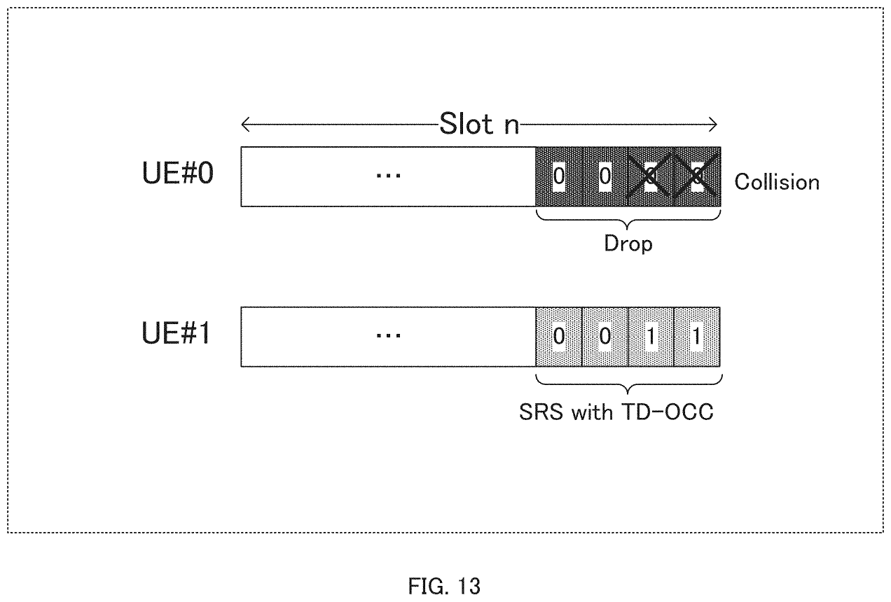

FIGS. 13, 14, and 15 illustrate examples of dropping of SRSs. In the examples illustrated in FIGS. 13, 14, and 15, SRSs of the series patterns of four symbols are configured for each of UE #0 and UE #1. The following will describe, for example, a case where a slot is composed of 14 symbols, as in NR.

In FIG. 13, for example, in UE #0, a collide occurs in transmission timing between the two SRS symbols at the end of the slot and another uplink signal (e.g., PUCCH). Moreover, it is assumed that the priority of the SRS is lower than that of the other uplink signal. In this case, as illustrated in FIG. 13, terminal 200 may drop all SRS symbols with the TD-OCC applied, including the two SRS symbols colliding with the other uplink In other words, as illustrated in FIG. 13, terminal 200 drops, among the SRS with the TD-OCC applied, SRS symbols that do not collide with the other uplink signal in addition to the SRS symbols that collide with the other uplink signal.

Further, in FIG. 13, for example, base station 100 may determine that, based on the scheduling for UE #0, the SRS is not transmitted from UE #0 (i.e., SRS is dropped), since the SRS with the TD-OCC applied collides with the other uplink signal in the two symbols at the end of the slot.

In the above-described manner, terminal 200 may drop the SRS placed in a plurality of symbols in a case where the priority at the time of collision is lower in the SRS than in the other uplink signal, for example. Thus, it is possible to suppress an occurrence of giving interference to another UE multiplexed in the same resource (UE #1 in FIG. 13).

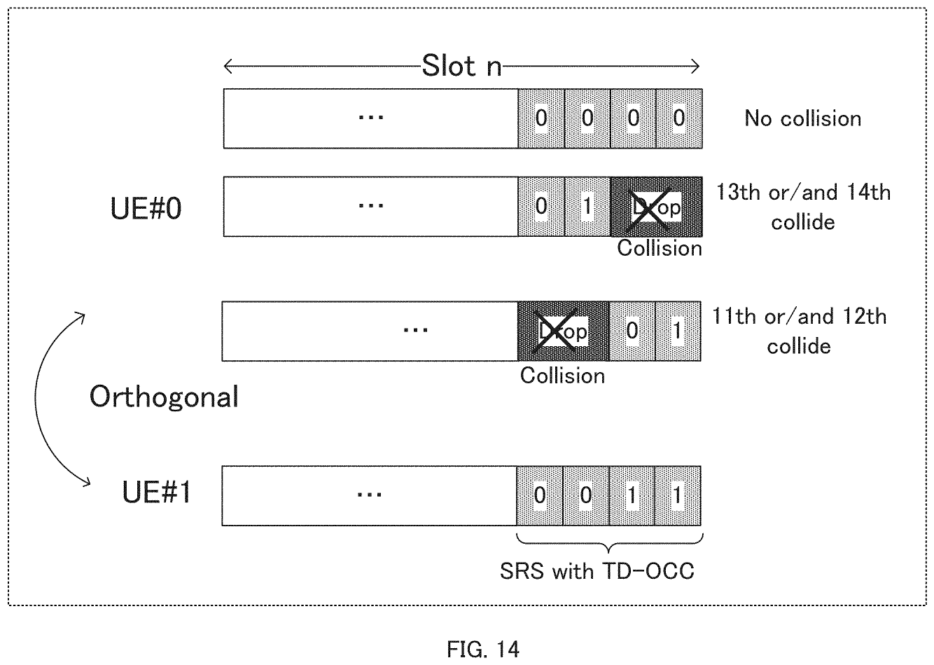

In FIG. 14, for example, terminal 200 may drop an SRS mapped to symbols in an OCC sequence length unit (e.g., minimum unit). For example, as illustrated in FIG. 14, in a case where the SRS and the other uplink signal collide at least one of the 13th and 14th of the slot, terminal 200 may drop the SRS placed in two symbols (e.g., 13th and 14th symbols) which are the minimum unit of the OCC sequence length, including the colliding symbol. Similarly, for example, as illustrated in FIG. 14, in a case where the SRS and the other uplink signal collide at least one of the 11th and 12th of the slot, terminal 200 may drop the SRS placed in two symbols (e.g., 11th and 12th symbols) which are the minimum unit of the OCC sequence length, including the colliding symbol.

Moreover, terminal 200 may, for example, change the OCC sequence that is applied to an SRS symbol after the dropping into a previously specified (or configured) OCC sequence. By way of example, in a case where an SRS resource set configured with a parameter for an Aperiodic SRS and indicating an SRS symbol position overlapping (e.g., identical to) the transmission symbol position of the other uplink signal is present, terminal 200 may apply sequence information included in the SRS resource set.

For example, the SRS resource set illustrated in FIG. 7 may be configured for terminal 200. Further, as illustrated in FIG. 14, in a case where SRS symbol positions to be actually transmitted by terminal 200 after the dropping are 11th and 12th symbols (i.e., in a case where 13th and 14th symbols are dropped), terminal 200 may use, in FIG. 7, the sequence information={0, 1} that is defined by the SRS resource set number=2 in which the SRS symbol positions to be transmitted (11th and 12th) and the symbol position is collided.

Similarly, as illustrated in FIG. 14, for example, in a case where SRS symbol positions to be actually transmitted by terminal 200 after the dropping are 13th and 14th symbols (i.e., in a case where 11th and 12th symbols are dropped), terminal 200 may use. in FIG. 7, the sequence information={0, 1} that is defined by the SRS resource set number=3 in which the SRS symbol positions to be transmitted (13th and 14th) and the symbol position is collided.

Further, in FIG. 14, in a case where the SRS with the TD-OCC applied collides with another PUCCH, for example, base station 100 may determine that, based on the scheduling for UE #0, the SRS, among the SRS with the TD-OCC applied, is transmitted in collision-free symbols in the OCC sequence length unit.

Thus, in a case where the priority at the time of collision is lower in the SRS than in the other uplink signal, for example, terminal 200 may drop SRSs for the number of symbols in the sequence length unit of the OCC sequence, including the SRS symbols at which the transmission timing collides, and apply, to the SRSs that are not dropped, the OCC sequence of the sequence length based on the number of symbols that are not dropped. This allows terminal 200 to maintain the orthogonality of the SRSs between another UE and transmit the SRS with the TD-OCC applied even when dropping some of the SRS symbols of the SRS with the TD-OCC applied.

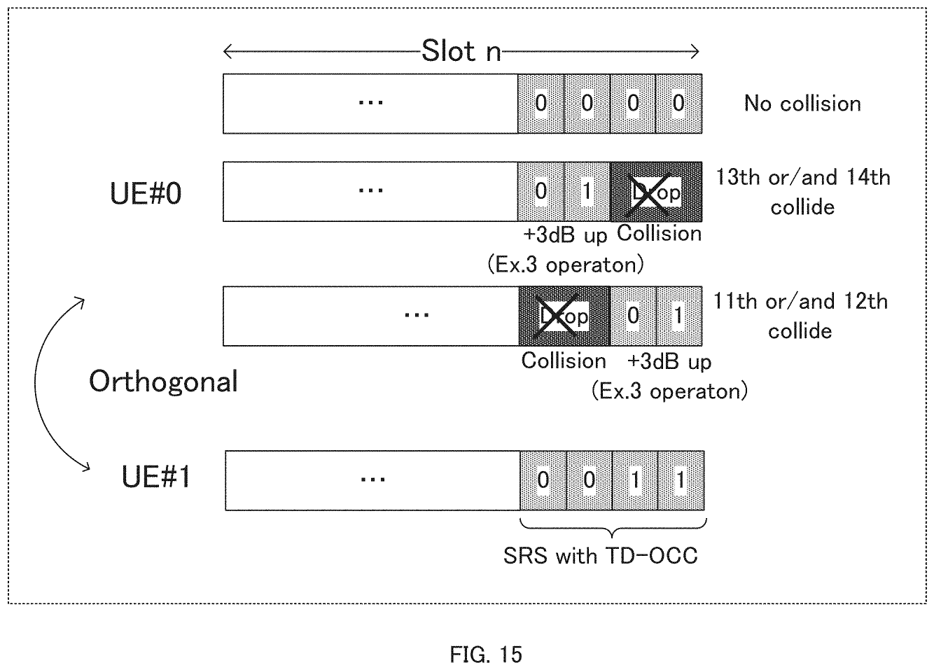

In FIG. 15, for example, terminal 200 may apply a power boost (e.g., increasing transmission power) to SRS that is not dropped in addition to the operation in FIG. 14.

By way of example, in UE #0 illustrated in FIG. 15, the dropping of the SRS symbols reduces the SRS symbols to be transmitted from four symbols to two symbols. Terminal 200 may then increase a transmission power by 3 dB for the two symbols to be transmitted, for example. This makes it possible to improve a symbol combination gain in base station 100 on the reception side. In other words, the increase in the transmission power for the SRS can compensate for the deterioration of the symbol combination gain caused by the reduction in the number of symbols by the dropping.

This allows terminal 200 to maintain the orthogonality of the SRSs between another UE and transmit the SRS with the TD-OCC applied even when dropping some of the SRS symbols of the SRS with the TD-OCC applied. Further, the channel estimation accuracy in base station 100 can be improved by increasing the transmission power for the SRS.s

Note that, terminal 200 may switch between, for example, the operation of dropping all of the SRS transmission as in Example 1 and the operation of dropping some of the SRS transmission and performing the remains of the SRS transmission by changing the OCC sequence as in Example 2. For example, base station 100 may transmit (i.e., instruct or indicate), to terminal 200, information indicating such switching. The information indicating the switching may be, for example, information (e.g., one bit) indicating whether all of the SRS transmission is dropped as in Example 1, or some of the SRS transmission are dropped and the remains of the SRS transmission are performed by changing the OCC sequence as in Example 2. This information may be included in, for example, control information (e.g., DCI) addressed to terminal 200.

Further, dropping processing of the SRS is not limited to the non-transmission processing of the SRS. For example, the dropping processing of the SRS may be processing of transmission with reduced transmission power (level) for the SRS, as compared to the case without the collision with another uplink signal. In one example, in a case where transmission hands are different between of the SRS and the other uplink signal although a collide occurs in transmission timing therebetween (e.g., in a case where Carrier Aggregation, V2X, or the like), terminal 200 may configure distribution of the transmission power for the signal according to the priority.

In the above-described examples, the collision in same terminal 200 between the SRS and the uplink signal has been described, but the collision between the SRS and the other uplink signal is not limited to the collision within the same terminal 200, and the rule of the priority or the drop processing described above may be applied to a collision between terminals 200 different from each other. In the case of the collision between terminals 200 different from each other, for example, base station 100 may indicate an Uplink cancellation indication (UL CI) to cause cancelation (e.g., dropping) of the transmission, for terminal 200 that transmits an uplink signal having a lower priority. For example, a rule may be defined by the specifications that the transmission of the SRS with the TD-OCC applied cannot be cancelled by the UL CI, for the purpose of increasing the priority of the SRS with the TD-OCC applied over the priority of the other uplink signal.

The examples of SRS transmission/reception processing based on the priority have been each described, thus far.

In the manner described above, in the present Embodiment, it is possible to suppress an occurrence of the dropping of the SRS with the TD-OCC applied by configuring the priority of the SRS with the TD-OCC applied higher than the priority of another uplink signal. Suppressing the occurrence of the dropping of the SRS can, for example, suppress an occurrence of interference between SRSs, and thus, the channel estimation accuracy with the SRS in base station 100 can be improved.

Further, in the present Embodiment, for example, for the SRS with the TD-OCC applied, SRS symbols are dropped at least in the minimum unit of the OCC sequence, including SRS symbols that do not collide, and the OCC sequence to be applied to the remaining transmission symbols is changed, This makes it possible to maintain the orthogonality of the SRSs with the TD-OCC in terminal 200 even when the SRS is dropped, and thus, the channel estimation accuracy with the SRS in base station 100 can be improved.

Note that, in the present Embodiment, a method for configuring an Aperiodic SRS for terminal 200 is not limited to the method of Embodiment 1 and may be other methods, for example.

Exemplary embodiments of the present disclosure have been each described, thus far.

In an exemplary embodiment of the present disclosure, the orthogonal sequence is not limited to an OCC sequence and may be other sequences.

Further, in an exemplary embodiment of the present disclosure, a case has been described where the SRS configuration information is configured for terminal 200 by higher layer signaling (e.g., RRC layer signaling), but the configuration of the SRS configuration information is not limited to the configuration by the higher layer signaling and may be by other signaling (e.g., physical layer signaling). Moreover, a case has been described where the parameter relating to the SRS with the TD-OCC applied (e.g., TD-OCC information) is indicated by the LACI to terminal 200, but the parameter relating to the SRS with the TD-OCC applied may be indicated, to terminal 200, by a signal (or information) different from the DCI.

Further, in an exemplary embodiment of the present disclosure, an object to which a resource such as an orthogonal sequence or a symbol position is not limited to a reference signal such as an SRS and may be other signals (or information). in one example, an exemplary embodiment of the present disclosure may be applied to, instead of the SRS, a response signal (e.g., also referred to as ACK/NACK or HARQ-ACK) to data.

### Control Signal

In an exemplary embodiment of the present disclosure, the downlink control signal (or downlink control information) may be, for example, a signal (or information) transmitted at a Physical Downlink Control Channel (PDCCH) in the physical layer, or a signal (or information) transmitted at Medium Access Control (MAC) or Radio Resource Control (RRC) in the higher layer. In addition, the signal (or information) is not limited to a case of being indicated by the downlink control signal and may be previously specified by the specifications (or standards) or may be previously configured in a base station and a terminal.

In an exemplary embodiment of the present disclosure, the uplink control signal (or uplink control information) may be, for example, a signal (or information) transmitted in a PDCCH in the physical layer, or a signal (or information) transmitted in MAC or RRC in the higher layer. In addition, the signal (or information) is not limited to a case of being indicated by the uplink control signal and may be previously specified by the specifications (or standards) or may be previously configured in a base station and a terminal. Further, the uplink control signal may be replaced with, for example, uplink control information (UCI), 1st stage sidelink control information (SCI), or 2nd stage SCI.

### Base Station

In an exemplary embodiment of the present disclosure, the base station may be a transmission reception point (TRP), a clusterhead, an access point, a remote radio head (RRH), an eNodeB (eNB), a gNodeB (gNB), a base station (BS), a base transceiver station (BTS), a base unit, or a gateway, for example. In addition, in sidelink communication, a terminal may be adopted instead of a base station. Further, instead of a base station, a relay apparatus may be adopted for relaying the communication between a higher node and a terminal.

### Uplink/Downlink/Sidelink

An exemplary embodiment of the present disclosure may be applied to, for example, any of the uplink, downlink, and sidelink. In one example, an exemplary embodiment of the present disclosure may be applied to a Physical Uplink Shared Channel (PUSCH), a Physical Uplink Control Channel (PUCCH), and a Physical Random Access Channel (PRACH) in uplink, a Physical Downlink Shared Channel (PDSCH), a PDCCH, and a Physical Broadcast Channel (PBCH) in downlink, or a Physical Sidelink Shared Channel (PSSCH), a Physical Sidelink Control Channel (PSCCH), and a Physical Sidelink Broadcast Channel (PSBCH) in sidelink.

The PDCCH, the PDSCH, the PUSCH, and the PUCCH are examples of a downlink control channel, a downlink data channel, an uplink data channel, and an uplink control channel, respectively. Further, the PSCCH and the PSSCH are examples of a side link control channel and a side link data channel, respectively. Further, the PBCH and the PSBCH are examples of a broadcast channel, and the PRACH is an example of a random access channel.

### Data Channel/Control Channel

An exemplary embodiment of the present disclosure may be applied to, for example, any of a data channel and a control channel. In one example, a channel in an exemplary embodiment of the present disclosure may be replaced with any of a PDSCH, a PUSCH, and a PSSCH for the data channel, or a PDCCH, a PUCCH, a PBCH, a PSCCH, and a PSBCH for the control channel.

### Reference Signal

In an exemplary embodiment of the present disclosure, the reference signals are signals known to both a base station and a mobile station and each reference signal may be referred to as a reference signal (RS) or sometimes a pilot signal. Each reference signal may be any of a Demodulation Reference Signal(DMRS); a Channel State Information-Reference Signal (CSI-RS); a Tracking Reference Signal (TRS); a Phase Tracking Reference Signal (PTRS); a Cell-specific Reference Signal (CRS); or a Sounding Reference Signal (SRS).

### Time Interval

In an exemplary embodiment of he present disclosure, time resource units are not limited to one or a combination of slots and symbols and may be time resource units, such as frames, superframes, subframes, slots, time slot sribslots, minislots, or time resource units, such as symbols, orthogonal frequency division multiplexing (OFDM) symbols, single carrier-frequency division multiplexing access (SC-FDMA) symbols, or other time resource units. The number of symbols included in one slot is not limited to any number of symbols exemplified in the embodiments described above and may be other numbers of symbols.

### Frequency Band

An exemplary embodiment of the present disclosure may be applied to either of a licensed band or an unlicensed band,

### Communication

An exemplary embodiment of the present disclosure may be applied to any of the communication between a base station and a terminal, the communication between terminals (Sidelink communication, Uu link communication), and the communication for Vehicle to Everything (V2X). In one example, a channel in an exemplary embodiment of the present disclosure may be replaced with any of a PSCCH, a PSSCH, a Physical Sidelink Feedback Channel (PSFCH), a PSBCH, a PDCCH, a PUCCH, a PDSCH, a PUSCH, and a PBCH.

Further, an exemplary embodiment of the present disclosure may be applied to either of terrestrial networks or a non-terrestrial network (NTN) such as communication using a satellite or a high-altitude pseudolite (High Altitude Pseudo Satellite (HAPS)). Further, an exemplary embodiment of the present disclosure may be applied to a terrestrial network having a large transmission delay compared to the symbol length or slot length, such as a network with a large cell size and/or an ultra-wideband transmission network.

### Antenna Port

In an exemplary embodiment of the present disclosure, the antenna port refers to a logical antenna (antenna group) configured of one or more physical antennae. For example, the antenna port does not necessarily refer to one physical antenna and may refer to an array antenna or the like configured of a plurality of antennae. In one example, the number of physical antennae configuring the antenna port may not be specified, and the antenna port may be specified as the minimum unit with which a terminal station can transmit a Reference signal. Moreover, the antenna port may be specified as the minimum unit for multiplying a weight of a Precoding vector.

### 5G NR System Architecture and Protocol Stack

3GPP has been working on the next release for the 5th generation cellular technology (simply called “5G”), including the development of a new radio access technology (NR) operating in frequencies ranging up to 100 GHz. The first version of the 5G standard was completed at the end of 2017, which allows proceeding to 5G NR standard-compliant trials and commercial deployments of terminals (e.g., smartphones).

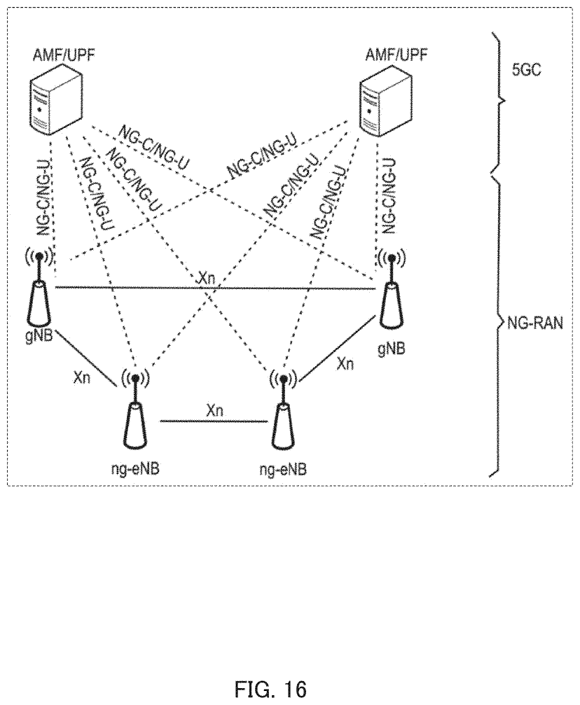

For example, the overall system architecture assumes an NG-RAN (Next Generation-Radio Access Network) that includes gNBs, providing the NG-radio access user plane (SDAP/PDCP/RLC/MAC/PHY) and control plane (RRC) protocol terminations towards the UE. The gNBs are interconnected with each other by means of the Xn interface. The gNBs are also connected by means of the Next Generation (NG) interface to the NGC (Next Generation Core), more specifically to the AMF (Access and Mobility Management Function) (e.g., a particular core entity performing the AMF) by means of the NG-C interface and to the UPF (User Plane Function) (e.g., a particular core entity performing the UPF) by means of the NG-U interface. The NG-RAN architecture is illustrated in FIG. 16 (see e.g., 3GPP TS 38.300 v15.6.0, section 4).

The user plane protocol stack for NR (see e.g., 3GPP TS 38.300, section 4.4.1) includes the PDCP (Packet Data Convergence Protocol, see clause 6.4 of TS 38.300), RLC (Radio Link Control, see clause 6.3 of IS 38.300) and MAC (Medium Access Control, see clause 6.2 of IS 38.300) sublayers, which are terminated in the gNB on the network side. Additionally, a new Access Stratum (AS) sublayer (SDAP, Service Data Adaptation Protocol) is introduced above the PDCP (see e.g., clause 6.5 of 3GPP TS 38.300). A control plane protocol stack is also defined for NR (see for instance TS 38.300, section 4.4.2). An overview of the Layer 2 functions is given in clause 6 of IS 38.300. The functions of the PDCP, RLC, and MAC sublayers are listed respectively in clauses 6.4, 6.3, and 6.2 of IS 38.300. The functions of the RRC layer are listed in clause 7 of TS 38.300.

For instance, the Medium Access Control layer handles logical-channel multiplexing, and scheduling and scheduling-related functions, including handling of different numerologies.

The physical layer (PHY) is for example responsible for coding, PHY HARQ processing, modulation, multi-antenna processing, and mapping of the signal to the appropriate physical time-frequency resources. The physical layer also handles mapping of transport channels to physical channels. The physical layer provides services to the MAC layer in the form of transport channels. A physical channel corresponds to the set of time-frequency resources used for transmission of a particular transport channel, and each transport channel is mapped to a corresponding physical channel. Examples of the physical channel include a Physical Random Access Channel (PRACH), a Physical Uplink Shared Channel (PUSCH), and a Physical Uplink Control Channel (PUCCH) as uplink physical channels, and a Physical Downlink Shared Channel (PDSCH), a Physical Downlink Control Channel (PDCCH), and a Physical Broadcast Channel (PBCH) as downlink physical channels.

Use cases/deployment scenarios for NR could include enhanced mobile broadband (eMBB), ultra-reliable low-latency communications (URLLC), and massive machine type communication (mMTC), which have diverse requirements in terms of data rates, latency, and coverage. For example, eMBB is expected to support peak data rates (20 Gbps for downlink and 10 Gbps for uplink) and user-experienced data rates on the order of three times what is offered by IMT-Advanced. On the other hand, in case of URLLC, the tighter requirements are put on ultra-low latency (0.5 ms for UL and DL each for user plane latency) and high reliability (1-10-5 within 1 ms). Finally, mMTC may preferably require high connection density (1,000,000 devices/km² in an urban environment), large coverage in harsh environments, and extremely long-life battery for low cost devices (15 years).

Therefore, the OFDM numerology (e.g., subcarrier spacing, OFDM symbol duration, cyclic prefix (CP) duration, and number of symbols per scheduling interval) that is suitable for one use case might not work well for another. For example, low-latency services may preferably require a shorter symbol duration (and thus larger subcarrier spacing) and/or fewer symbols per scheduling interval (aka, TTI) than an mMTC service. Furthermore, deployment scenarios with large channel delay spreads may preferably require a longer CP duration than scenarios with short delay spreads. The suhcarrier spacing should be optimized accordingly to retain the similar CP overhead. NR may support more than one value of subcarrier spacing. Correspondingly, subcarrier spacings of 15 kHz, 30 kHz, and 60 kHz . . . are being considered at the moment. The symbol duration Tu and the suhcarrier spacing Af are directly related through the formula Δf=1/Tu. In a similar manner as in LTE systems, the term “resource element” can be used to denote a minimum resource unit being composed of one subcarrier for the length of one OFDM/SC-FDMA symbol.

In the new radio system 5G-NR for each numerology and each carrier, resource grids of subcarriers and OFDM symbols are defined respectively for uplink and downlink. Each element in the resource grids is called a resource element and is identified based on the frequency index in the frequency domain and the symbol position in the time domain (see 3GPP TS 38.211 v15.6.0).

### Functional Split Between NG-RAN and 5GC in 5G NR

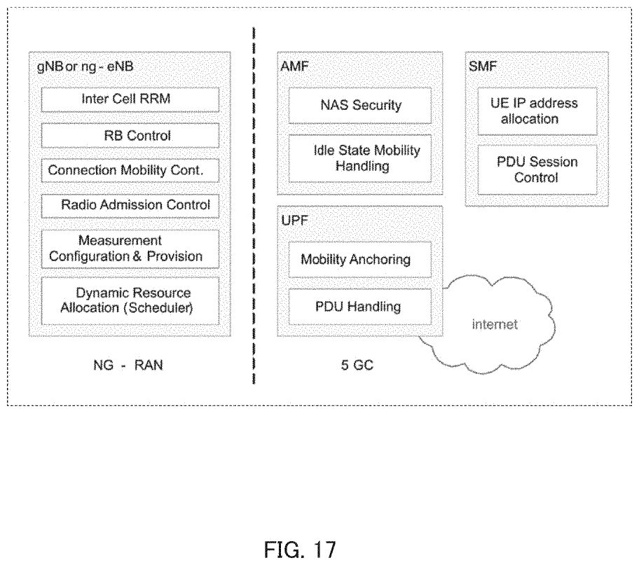

FIG. 17 illustrates the functional split between the NG-RAN and the 5GC. A logical node of the NG-RAN is gNB or ng-eNB. The 5GC includes logical nodes AMF, UPF, and SMF.

For example, gNB and ng-eNB hosts the following main functions:
Radio Resource Management functions such as Radio Bearer Control, Radio Admission Control, Connection Mobility Control, and dynamic allocation (scheduling) of both uplink and downlink resources to a UE;
IP header compression, encryption, and integrity protection of data;
Selection of an AMF during UE attachment in such a case when no routing to an AMF can be determined from the information provided by the UE;
Routing user plane data towards the UPF;
Routing control plane information towards the AMF;
Connection setup and release;
Scheduling and transmission of paging messages;
Scheduling and transmission of system broadcast information (originated from the AMF or an operation management maintenance function (OAM: Operation, Admission; Maintenance));
Measurement and measurement reporting configuration for mobility and scheduling;
Transport level packet marking in the uplink;
Session management;
Support of network slicing;
QoS flow management and mapping to data radio bearers;
Support of UEs in the RRC_INACTIVE state;
Distribution function for NAS messages;
Radio access network sharing;
Dual connectivity; and
Tight interworking between NR and E-UTRA.

The Access and Mobility Management Function (AMF) hosts the following main functions:
Function of Non-Access Stratum (NAS) signaling termination;
NAS signaling security;
Access Stratum (AS) security control;
Inter-Core Network (CN) node signaling for mobility between 3GPP access networks;
Idle mode UE, reachability (including control and execution of paging retransmission);
Registration area management;
Support of intra-system and inter-system mobility;
Access authentication:
Access authorization including check of roaming rights;
Mobility management control (subscription and policies);
Support of network slicing; and
Session Management Function (SMF) selection.

In addition, the User Plane Function (UPF) hosts the following main functions:
Anchor Point for intra-/inter-RAT mobility (when applicable);
External Protocol Data Unit (PDU) session point for interconnection to a data network;
Packet routing and forwarding;
Packet inspection and a user plane part of Policy rule enforcement;
Traffic usage reporting;
Uplink classifier to support routing traffic flows to a data network;
Branching point to support multi-homed PDU session;
QoS handling for user plane (e.g., packet filtering; gating, UL/DL rate enforcement);
Uplink traffic verification (SDF to QoS flow mapping); and
Function of downlink packet buffering and downlink data notification triggering.

Finally, the Session Management Function (SMF) hosts the following main functions:
Session management;
UE IP address allocation and management;
Selection and control of UPF;
Configuration function for traffic steering at the User Plane Function (UPF) to route traffic to a proper destination;
Control part of policy enforcement and QoS; and
Downlink data notification.

### RRC Connection Setup and Reconfiguration Procedure

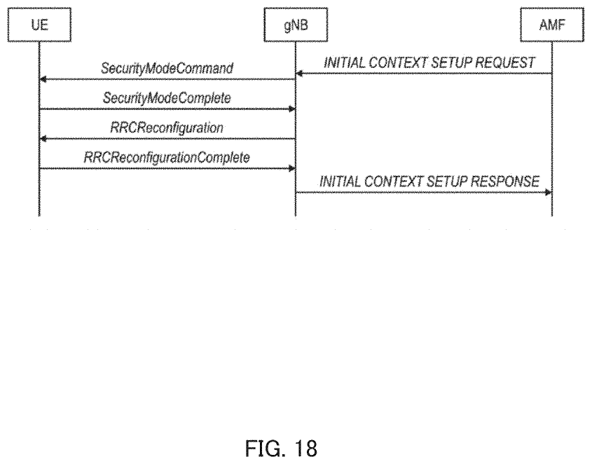

FIG. 18 illustrates some interactions between a UE, gNB, and AMF (a 5GC Entity) performed in the context of a transition of the UE from RRC_IDLE to RRC_CONNECTED for the NAS part (see TS 38 300 v15.6.0).

The RRC is higher layer signaling (protocol) used to configure the UE and gNB. With this transition, the AMF prepares UE context data (which includes, for example, a PDU session context, security key, UE Radio Capability, UE Security Capabilities, and the like) and sends it to the gNB with an INITIAL CONTEXT SETUP REQUEST. Then, the gNB activates the AS security with the UE. This activation is performed by the gNB transmitting to the UE a SecurityModeCommand message and by the UE responding to the gNB with the SecurityModeComplete message. Afterwards, the gNB performs the reconfiguration to setup the Signaling Radio Bearer 2 (SRB2) and Data Radio Bearer(s) (DRB(s)) by means of transmitting to the UE the RRCReconfiguration message and, in response, receiving by the gNB the RRCReconfigurationComplete from the UE. For a signaling-only connection, the steps relating to the RRCReconfiguration are skipped since SRB2 and DRBs are not set up. Finally, the gNB notifies the AMF that the setup procedure is completed with INITIAL CONTEXT SETUP RESPONSE.

Thus, the present disclosure provides a 5th Generation Core (5GC) entity (e.g., AMF, SMF, or the like) including control circuitry, which, in operation, establishes a Next Generation (NG) connection with a gNodeB, and a transmitter, which in operation, transmits an initial context setup message to the gNodeB via the NG connection such that a signaling radio bearer between the gNodeB and a User Equipment WE) is set up. Specifically, the gNodeB transmits Radio Resource Control (RRC) signaling including a resource allocation configuration Information Element (IE) to the UE via the signaling radio bearer. Then, the UE performs an uplink transmission or a downlink reception based on the resource allocation configuration.

### Usage Scenarios of IMT for 2020 and Beyond

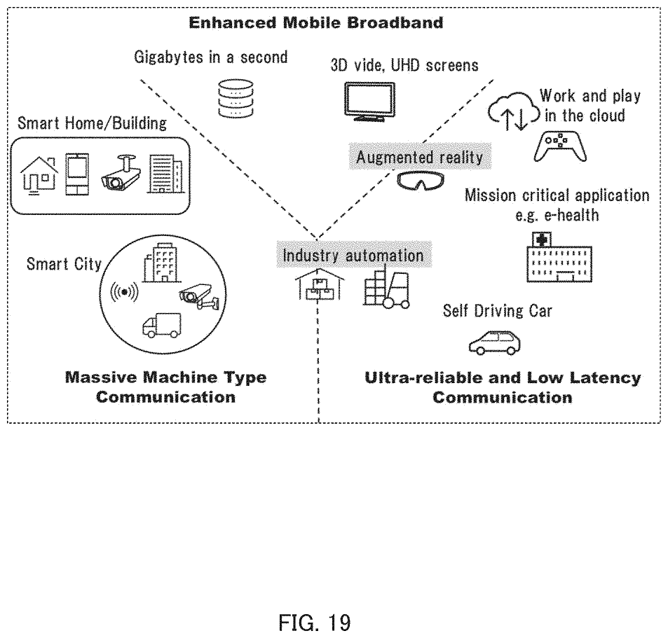

FIG. 19 illustrates some of the use cases for 5G NR. In 3rd generation partnership project new radio (3GPP NR), three use cases are being considered that have been envisaged to support a wide variety of services and applications by IMT-2020. The specification for the phase 1 of enhanced mobile-broadband (eMBB) has been concluded. In addition to further extending the eMBB support, the current and future work would involve the standardization for ultra-reliable and low-latency communications (URLLC) and massive machine-type communications (mMTC). FIG. 19 illustrates some examples of envisioned usage scenarios for IMT for 2020 and beyond (see e.g., ITU-R M.2083 FIG. 2).

The URLLC use case has stringent requirements for capabilities such as throughput, latency and availability. The URLLC use case has been envisioned as one of the enablers for future vertical applications such as wireless control of industrial manufacturing or production processes, remote medical surgery, distribution automation in a smart grid, transportation safety. Ultra-reliability for URLLC is to be supported by identifying the techniques to meet the requirements set by TR 38.913. Fax NR URLLC in Release 15, key requirements include a target user plane latency of 0.5 ms for UL (uplink) and 0.5 ms for DL (downlink). The general URLLC requirement for one transmission of a packet is a block error rate (BLEB) of 1E-5 for a packet size of 32 bytes with a user plane latency of 1 ms.

From the physical layer perspective, reliability can be improved in a number of possible ways. The current scope for improving the reliability involves defining separate CQI tables for URLLC, more compact DCI formats, repetition of PDCCH, or the like. However, the scope may widen for achieving ultra-reliability as the NR becomes more stable and developed (for NR URLLC key requirements). Particular use cases of NR URLLC in Rel. 15 include Augmented Reality/Virtual Reality (AR/VR), e-health, e-safety, and mission-critical applications.

Moreover, technology enhancements targeted by NR tank aim at latency improvement and reliability improvement. Technology enhancements for latency improvement include configurable numerology, non slot-based scheduling with flexible mapping, grant free (configured grant) uplink, slot-level repetition for data channels, and downlink pre-emption. Pre-emption means that a transmission for which resources have already been allocated is stopped, and the already allocated resources are used for another transmission that has been requested later, but has lower latency/higher priority requirements. Accordingly, the already granted transmission is pre-empted by a later transmission. Ike-emption is applicable independent of the particular service type. For example, a transmission for a service-type A (URLLC) may be pre-empted by a transmission for a service type B (such as eMBB). Technology enhancements with respect to reliability improvement include dedicated CQI-MCS tables for the target BLER of 1E-5.

The use case of mMTC (massive machine type communication) is characterized by a very large number of connected devices typically transmitting a relatively low volume of non-delay sensitive data. Devices are required to be low cost and to have a very long battery life. From NR perspective, utilizing very narrow bandwidth parts is one possible solution to have power saving from UE perspective and enable long battery life.

As mentioned above, it is expected that the scope of reliability in NR becomes wider. One key requirement to all the cases, for example, for URLLC and mMTC, is high reliability or ultra-reliability. Several mechanisms can improve the reliability from radio perspective and network perspective. In general, there are a few key potential areas that can help improve the reliability. Among these areas are compact control channel information, data/control channel repetition, and diversity with respect to frequency, time and/or the spatial domain. These areas are applicable to reliability improvement in general, regardless of particular communication scenarios.

For NR URLLC, further use cases with tighter requirements have been envisioned such as factory automation, transport industry and electrical power distribution. The tighter requirements are higher reliability (up to 10-6 level), higher availability, packet sizes of up to 256 bytes, time synchronization up to the extent of a few its (where the value can be one or a few μs depending on frequency range and short latency on the order of 0.5 to 1 ms (in particular a target user plane latency of 0.5 ms), depending on the use cases).

Moreover, for NR URLLC, several technology enhancements from physical layer perspective have been identified. Among these are PDCCH (Physical Downlink Control Channel) enhancements related to compact DCL PDCCH repetition, increased PDCCH monitoring. Moreover, UCI (Uplink Control Information) enhancements are related to enhanced HARQ (Hybrid Automatic Repeat Request) and CSI feedback enhancements. Also PUSCH enhancements related to mini-slot level hopping and retransmission/repetition enhancements are possible. The term “mini-slot” refers to a Transmission Time Interval (TTI) including a smaller number of symbols than a slot (a slot comprising fourteen symbols).

### QoS Control

The 5G QoS (Quality of Service) model is based on QoS flows and supports both QoS flows that require guaranteed flow bit rate (GBR QoS flows) d QoS flows that do not require guaranteed flow bit rate (non-GBR QoS Flows). At NAS level, the QoS flow is thus the finest granularity of QoS differentiation in a PDU session. A QoS flow is identified within a PDU session by a QoS flow ID (QFI) carried in an encapsulation header over NG-U interface.

For each UE, 5GC establishes one or more PDU sessions. For each UE, the NG-RAN establishes at least one Data Radio Bearer (DRB) together with the PDU session, e.g., as illustrated above with reference to FIG. 18. Further, additional DRB(s) for QoS flow(s) of that PDU session can be subsequently configured (it is up to NG-RAN when to do so). The NG-RAN maps packets belonging to different PDU sessions to different DRBs. NAS level packet filters in the UE and in the 5GC associate UL and DL packets with QoS Flows, whereas AS-level mapping rules in the UE and in the NG-RAN associate UL and DL QoS Flows with DRBs.

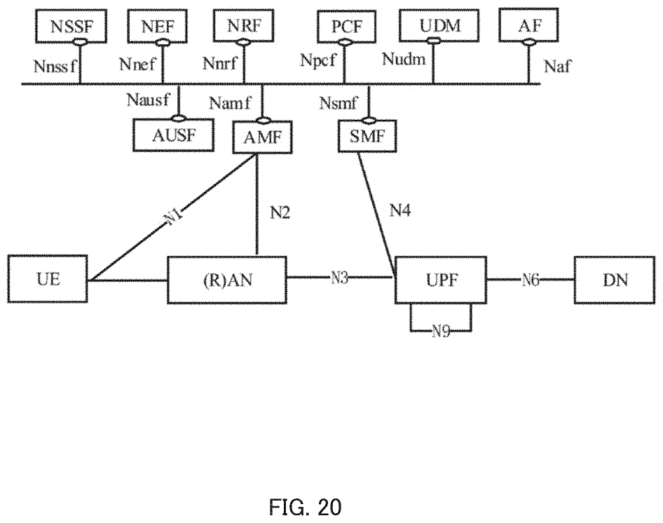

FIG. 20 illustrates a 5G NR non-roaming reference architecture (see TS 23.501 v16.1.0, section 4.23). An Application Function (AF) (e.g., an external application server hosting 5G services, exemplarily described in FIG. 19) interacts with the 3GPP Core Network in order to provide services, for example to support application influencing on traffic routing, accessing Network Exposure Function (NEF) or interacting with the policy framework for policy control (e.g., QoS control) (see Policy Control Function, PCF). Based on operator deployment, Application Functions considered to be trusted by the operator can be alto-wed to interact directly with relevant Network Functions. Application Functions not allowed by the operator to access directly the Network Functions use the external exposure framework via the NEF to interact with relevant Network Functions.

FIG. 20 illustrates further functional units of the 5G architecture, namely Network Slice Selection Function (NSSF), Network Repository Function (NRF), Unified Data Management (UDM), Authentication Server Function (AUSF), Access and Mobility Management Function (AMF), Session Management Function (SMF), and Data Network (DN, e.g., operator services, Internet access, or third party services). All of or a part of the core network functions and the application services may be deployed and running on cloud computing environments.

In the present disclosure, thus, an application server (e.g., AF of the 5G architecture), is provided that includes: a transmitter, which in operation, transmits a request containing a QoS requirement for at least one of URLLC, eMMB and mMTC services to at least one of functions (such as NEF, AMF, SMF, PCF, and UPF) of the 5GC to establish a PDU session including a radio bearer between a gNodeB and a UE in accordance with the QoS requirement; and control circuitry, which, in operation, performs the services using the established PDU session.

The present disclosure can be realized by software, hardware, or software in cooperation with hardware. Each functional block used in the description of each embodiment described above can be partly or entirely realized by an LSI such as an integrated circuit, and each process described in the each embodiment may be controlled partly or entirely by the same LST or a combination of LSIs. The LSI may be individually formed as chips, or one chip may be formed so as to include a part or all of the functional blocks. The LSI may include a data input and output coupled thereto. The LSI herein may be referred to as an IC, a system LSI, a super LSI, or an ultra LSI depending on a difference in the degree of integration.

However, the technique of implementing an integrated circuit is not limited to the LSI and may be realized by using a dedicated circuit, a general-purpose processor, or a special-purpose processor. In addition, a FPGA (Field Programmable Gate Array) that can be programmed after the manufacture of the LSI or a reconfigurable processor in which the connections and the settings of circuit cells disposed inside the LSI can be reconfigured may be used. The present disclosure can be realized as digital processing or analogue processing.

If future integrated circuit technology replaces LSIs as a result of the advancement of semiconductor technology or other derivative technology, the functional blocks could be integrated using the future integrated circuit technology. Biotechnology can also be applied.

The present disclosure can be realized by any kind of apparatus, device or system having a function of communication, which is referred to as a communication apparatus. The communication apparatus may comprise a transceiver and processing/control circuitry. The transceiver may comprise and/or function as a receiver and a transmitter. The transceiver, as the transmitter and receiver, may include an RF (radio frequency) module and one or more antennas. The RF module may include an amplifier, an RF modulator/demodulator, or the like. Some non-limiting examples of such a communication apparatus include a phone (e.g., cellular (cell) phone, smart phone), a tablet, a personal computer (PC) (e.g., laptop, desktop, netbook), a camera (e.g., digital still/video camera), a digital player (digital audio/video player), a wearable device (e.g., wearable camera, smart watch, tracking device), a game console, a digital book reader, a telehealth/telemedicine (remote health and medicine) device, and a vehicle providing communication functionality (e.g., automotive, airplane, ship), and various combinations thereof.

The communication apparatus is not limited to be portable or movable, and may also include any kind of apparatus, device or system being non-portable or stationary, such as a smart home device (e.g., an appliance, lighting, smart meter, control panel), a vending machine, and any other “things” in a network of an “Internet of Things (IoT).”

The communication may include exchanging data through, for example, a cellular system, a wireless LAN system, a satellite system, etc., and various combinations thereof.

The communication apparatus may comprise a device such as a controller or a sensor which is coupled to a communication device performing a function of communication described in the present disclosure. For example, the communication apparatus may comprise a controller or a sensor that generates control signals or data signals which are used by a communication device performing a communication function of the communication apparatus.

The communication apparatus also may include an infrastructure facility, such as, e.g., a base station, an access point, and any other apparatus, device or system that communicates with or controls apparatuses such as those in the above non-limiting examples.

A terminal according to an exemplary embodiment of the present disclosure includes: reception circuitry, which, in operation, receives information indicating any of a plurality of candidates for a resource used for transmitting a reference signal; and control circuitry, which, in operation, controls, based on the information, an orthogonal sequence that is applied to the reference signal to be transmitted at a certain timing.

In an exemplary embodiment of the present disclosure, the reception circuitry, receives first information indicating the plurality of candidates for at least one of a number of the orthogonal sequence and/or positions of a plurality of symbols in a unit time duration.

In an exemplary embodiment of the present disclosure, the information includes second information indicating any one or more of the plurality of candidates, in which the second information indicates a portion of the plurality of candidates for the first information

In an exemplary embodiment of the present disclosure, in a case where the certain timing collides with a timing of transmitting another uplink signal, the control circuitry executes control for application of the orthogonal sequence to the reference signal based on a priority of each of the reference signal and the other uplink signal.

In an exemplary embodiment of the present disclosure, the other uplink signal is an uplink control channel including channel state information, and the control circuitry executes the control in a case where the priority of the reference signal is higher than that of the uplink control channel.

In an exemplary embodiment of the present disclosure, the control circuitry drops the reference signal in a case where the priority of the reference signal is lower than that of the other uplink signal.

In an exemplary embodiment of the present disclosure, in a case where the priority of the reference signal is lower than that of the other uplink signal, the control circuitry drops at least one of a plurality of the reference signals for a number of symbols in a sequence length unit of the orthogonal sequence, the symbols including a symbol at which the timing collides, and the control circuitry applies, in this case, to at least one of the plurality of reference signals that is not dropped, an orthogonal sequence of a sequence length based on a number of symbols that are not dropped.

In an exemplary embodiment of the present disclosure, the control circuitry increases a transmission power for the at least one of the plurality of reference signals that is not dropped.

A base station according to an exemplary embodiment of the present disclosure includes: transmission circuitry, which, in operation, transmits information indicating any of a plurality of candidates for a resource used for transmitting a reference signal; and control circuitry, which, in operation, controls, based on the information, an orthogonal sequence that is applied to the reference signal to be received at a certain timing.

A communication method according to an exemplary embodiment of the present disclosure includes: receiving, by a terminal, information indicating any of a plurality of candidates for a resource used for transmitting a reference signal; and controlling, by the terminal, based on the information, an orthogonal sequence that is applied to the reference signal to be transmitted at a certain timing.

A communication method according to an exemplary embodiment of the present disclosure includes: transmitting, by a base station, information indicating any of a plurality of candidates for a resource used for transmitting a reference signal; and controlling, by the base station, based on the information, an orthogonal sequence that is applied to the reference signal to be received at a certain timing.

The disclosure of Japanese Patent Application No. 2020-121430, filed on Jul. 15, 2020, including the specification, drawings and abstract, is incorporated herein by reference in its entirety.

### INDUSTRIAL APPLICABILITY

An exemplary embodiment of the present disclosure is useful for radio communication systems.

### REFERENCE SIGNS LIST

100 Base station

101, 203 Controller

102 Encoder/modulator

103, 206 Transmission processor

104, 207 Transmitter

105, 201 Receiver

106, 202 Reception processor

107 Data signal receiver

108 Reference signal receiver

200 Terminal

204 Reference signal generator

205 Data signal generator

1. A terminal, comprising:
reception circuitry, which in operation, receives information indicating any of a plurality of candidates for a resource used for transmitting a reference signal; and
control circuitry, which, in operation, controls, based on the information, an orthogonal sequence that is applied to the reference signal to be transmitted at a certain timing.

2. The terminal according to claim 1, wherein the reception circuitry receives first information indicating the plurality of candidates for at least one of a number of the orthogonal sequence and/or positions of a plurality of symbols in a unit time duration.

3. The terminal according to claim 2, wherein the information includes second information indicating any one or more of the plurality of candidates, wherein
the second information indicates a portion of the plurality of candidates for the first information.

4. The terminal according to claim 1, wherein, in a case where the certain timing collides with a timing of transmitting another uplink signal, the control circuitry executes control for application of the orthogonal sequence to the reference signal based on a priority of each of the reference signal and the other uplink signal.

5. The terminal according to claim 4, wherein:
the other uplink signal is an uplink control channel including channel state information, and
the control circuitry executes the control in a case where the priority of the reference signal is higher than that of the uplink control channel.

6. The terminal according to claim 4, wherein the control circuitry drops the reference signal in a case where the priority of the reference signal is lower than that of the other uplink signal.

7. The terminal according to claim 4, wherein, in a case where the priority of the reference signal is lower than that of the other uplink signal, the control circuitry drops at least one of a plurality of the reference signals for a number of symbols in a sequence length unit of the orthogonal sequence, the symbols including a symbol at which the timing collides, and the control circuitry applies, in this case, to at least one of the plurality of reference signals that is not dropped, an orthogonal sequence of a sequence length based on a number of symbols that are not dropped.

8. The terminal according to claim 7, wherein the control circuitry increases a transmission power for the at least one of the plurality of reference signals that is not dropped.

9. A base station, comprising:
transmission circuitry, which, in operation, transmits information indicating any of a plurality of candidates for a resource used for transmitting a reference signal; and
control circuitry, which, in operation, controls, based on the information, an orthogonal sequence that is applied to the reference signal to be received at a certain timing.

10. A communication method, comprising:
receiving, by a terminal, information indicating any of a plurality of candidates for a resource used for transmitting a reference signal; and
controlling, by the terminal, based on the information, an orthogonal sequence that is applied to the reference signal to be transmitted at a certain timing.

11. A communication method, comprising:
transmitting, by a base station, information indicating any of a plurality of candidates for a resource used for transmitting a reference signal; and
controlling, by the base station, based on the information, an orthogonal sequence that is applied to the reference signal to be received at a certain timing.
